(19) United States
(12) Patent Application Publication
(10) Pub. No.: US 2012/0209990 A1
(43) Pub. Date: Aug. 16, 2012

(54) METHOD AND SYSTEM FOR PROVIDING A ZERO RATING SERVICE TO AN END-USER DEVICE

(75) Inventor: Stephane Honore, Madrid (ES)

(73) Assignee: OPENWAVE SYSTEMS INC., Redwood City, CA (US)

(21) Appl. No.: 13/370,082

(22) Filed: Feb. 9, 2012

Related U.S. Application Data
(60) Provisional application No. 61/442,266, filed on Feb. 13, 2011.

(51) Int. Cl. G06F 15/173

(52) U.S. Cl. 709/224

(57) ABSTRACT

Methods and systems for providing a zero rating service to an end-user device are described. In one embodiment, a method for providing a zero rating service to an end-user device involves redirecting a request that is directed to a third party URL from an end-user device to a zero rating URL and performing a URL transformation in response to the redirected request. Other embodiments are also described.

### CROSS-REFERENCE TO RELATED APPLICATION

This application is entitled to the benefit of provisional U.S. Patent Application Ser. No. 61/442,266, filed Feb. 13, 2011, which is incorporated by reference herein.

### BACKGROUND

Nowadays, third parties can apply zero rating pricing (e.g. data traffic measured in bytes for their services/applications is not counted against a user data quota) by reaching agreements with network carriers such that the Uniform Resource Locators (URLs) of the third parties' services/applications are zero-rated by carrier billing infrastructures. A well-known example is 0.facebook.com which provides a limited version of the FACEBOOK site free of charge to the end-user. However, to avoid having to provision a large number of URLs in the carrier billing infrastructures, which is difficult, expensive, and time-consuming to implement, or to get into pricing conflicts between paid URLs and free URLs depending on the applications from which the traffic is originated, network carriers usually want third parties services/applications to use as few domains as possible. Thus, to sell services/applications in which data is included (e.g. data traffic for the services/applications is not counted against a user data quota), third parties have to invest resources and time to redesign/rewrite their services/applications to use as few domains as possible. In some cases where third party content delivery networks or content distribution networks (CDNs) are used, it might not even be possible to use specific domains required by the network carriers.

### SUMMARY

Methods and systems for providing a zero rating service to an end-user device are described. In one embodiment, a method for providing a zero rating service to an end-user device involves redirecting a request that is directed to a third party URL from an end-user device to a zero rating URL and performing a URL transformation in response to the redirected request. Other embodiments are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a network architecture.

FIG. 2 illustrates an exchange of messages that is used to implement an operation of the zero rating proxy of FIG. 1.

FIG. 3 shows an example redirection between third party URLs and a zero rating URL of the zero rating proxy depicted in FIG. 1.

FIG. 4 depicts a computer that includes a processor, memory, and a communications interface.

FIG. 5 is a process flow diagram of a method for providing a zero rating service to an end-user device in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

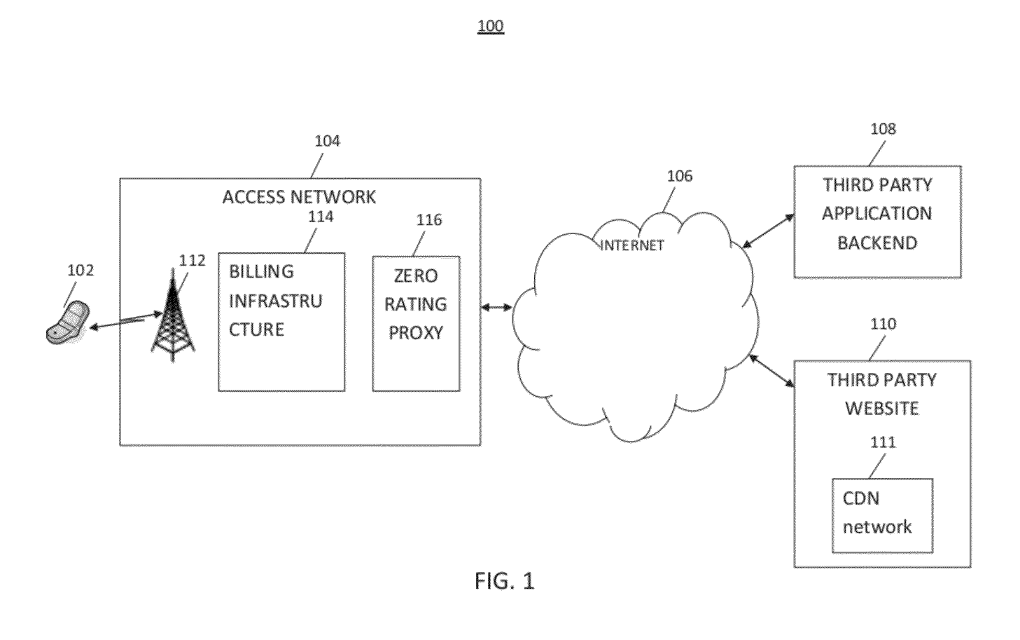

FIG. 1 depicts a schematic block diagram of one embodiment of a network architecture 100 that provides communications services. The network architecture depicted in FIG. 1 includes an end-user device 102, an access network 104, the Internet 106, a third party application backend 108, and a third party website 110. Although the network architecture is depicted and described with certain components and functionality, other embodiments of the network architecture may include fewer or more components to implement less or more functionality. For example, the network architecture may include any number of end-user device(s), access network(s), third party application backend(s), and/or third party website(s).

The end-user device 102 is configured to request content via the access network 104 on behalf of a user from one or more content providers, such as, the third party application backend 108 and potentially the third party website 110, which may include a CDN network 111. In an embodiment, the CDN is a computer system that contains copies of data placed at various points in a network to maximize access bandwidth. Data contained in the CDN may include (without being limited to) web objects, media files, software, documents, applications, real time media streams, and other delivery components (e.g. Domain Name System (DNS), routes, and database queries). The end-user device may be further configured to render received content for presenting to the user. The end-user device may include a native application or a web browser, such as Microsoft Internet Explorer, Mozilla Firefox, or Google Chrome, to perform at least part of the above-described functions. The user may be a single person, multiple persons, or other entity or entities. The content may be any type of content. For example, the content may include one or more webpage files, one or more text files, one or more image files, one or more audio files, or one or more video files, or any combination thereof. Some of the content can be served from the third party application backend or from the third party website. The end-user device may be any type of end-user device. The end-user device may communicate wirelessly, communicate through wires, or communicate wirelessly and through wires with other entity or entities. For example, the end-user device may include at least one communications interface (not shown) to communicate with the access network. Although the network architecture 100 is depicted in FIG. 1 as including one end-user device, in other embodiments, the network architecture includes more than one end-user device.

In the embodiment depicted in FIG. 1, the end-user device is a wireless device which can wirelessly communicate using radio frequency (RF) communications signals. The wireless device can support various different RF communications protocols, including without limitation, Global System for Mobile Communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols. The wireless device may be a handheld wireless device, such as a cell phone, a mobile phone, a smart phone, a pad computer, a Personal Digital Assistant (PDA), a handheld gaming device etc. Although the end-user device in the embodiment depicted in FIG. 1 is a wireless device, in other embodiments, the end-user device may be a wired communications device that accesses the Internet 106 via a dial-up connection, a digital subscriber line (DSL), or a cable modem.

The access network 104 is configured to facilitate wired and/or wireless communications between the end-user device 102 and the Internet 106. The access network can provide one or more interfaces to facilitate communications between the end-user device and one or more network entities, such as a Public Switched Telephone Network (PSTN), a Wide Area Network (WAN), Internet servers, hosts, etc. Data signals communicated between the end-user device and the access network include, but are not limited to, analog and/or digital signals for any type of communications mode. The access network may be a cellular access network, such as a 2G, a General Packet Radio Service (GPRS), an Enhanced Data rates for GSM Evolution (EDGE), a 3G or a 4G cellular network wireless service provider network, or a wireless/wired access network, such as a dial-up, DSL, or cable modem based ISP network with/without wireless access, which may be provided by one or more WLAN access points. A private enterprise network can also serve as an access network if end-user devices within the private enterprise network can access the Internet through the private enterprise network. Although some cellular/wireless/wired access networks are identified herein, it should be understood that the present disclosure is not limited to the cited cellular/wireless/wired access networks.

Although the network architecture 100 is depicted in FIG. 1 as including one access network 104, in other embodiments, the network architecture includes more than one access network. One or more access networks may be administered by a single entity or different entities. For example, one or more access networks may be managed by a single Internet service provider (ISP), a single wireless service provider, or a private enterprise. In an embodiment, at least one of the access networks includes an Internet gateway (not shown) that provides a gateway for communications between end-user devices and or connected to Internet-connected hosts and/or servers in the Internet. The Internet gateway may include a Serving GPRS Support Node (SGSN) and a Gateway GPRS Support Node (GGSN) or their respective evolution in LTE architectures.

In the embodiment depicted in FIG. 1, the access network 104 is a cellular/wireless access network. The access network includes a radio access network 112, a billing infrastructure 114, and a zero rating proxy 116. Although the zero rating proxy is depicted under the umbrella of the access network, it doesn't limit the possibility to deploy the zero rating proxy as a cloud service (e.g. in the Internet 106). The access network may be managed by a single Internet service provider (ISP), a single wireless service provider, or a private enterprise. For example, the access network can be managed by a single cellular carrier, such as AT&T, TMobile, or Verizon. Although the access network is depicted and described with certain components and functionality, other embodiments of the access network may include fewer or more components to implement less or more functionality.

The radio access network 112 is configured to facilitate radio communications between the end-user device 102 and the Internet 106. In an embodiment, the radio access network includes one or more base stations (not shown) to facilitate communications among wireless devices that are within a communications range of the base stations. Each base station has at least one RF transceiver and the base stations communicate with the wireless devices using RF communications signals. The radio access network facilitates network communications among multiple wireless devices within the same radio access network and between wireless devices in other radio access networks and provides interfaces to facilitate communications with other entities, such as a Public Switched Telephone Network (PSTN), a Wide Area Network (WAN), the Internet, Internet servers, hosts, etc., which are outside of the radio access network. Data signals communicated between the end-user device and the radio access network include, but are not limited to, analog and/or digital RF signals (i.e., radio waves) for any type of communications mode, including text messaging, multimedia messaging, voice calling, and Internet browsing. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that present disclosure is not limited to the cited wireless communications protocols.

The billing infrastructure 114 is configured to perform a billing function for the access network 104. The billing infrastructure may be a carrier billing infrastructure. In an embodiment, the billing infrastructure measures traffic volume from and to one or more end-user devices. In an embodiment, the billing infrastructure is located in the communications path between one or more end-user devices and the zero rating proxy 116 and measures traffic volume between the one or more end-user devices and the zero rating proxy. In the embodiment depicted in FIG. 1, the billing infrastructure may count communications data volume from and to the end-user device 102 against a data volume quota. In an embodiment, the end-user device is a smart phone of a subscriber of a wireless service network, which has a monthly (or daily or any other period) data volume quota of two gigabytes. The billing infrastructure counts communications data volume from and to the smart phone against the monthly data volume quota of two gigabytes of the subscriber or the smart phone. If the communications data volume from and to the smart phone is over the monthly data volume quota of two gigabytes, the billing infrastructure may charge the subscriber as a function of the difference between the current communications data volume from and to the smart phone and the monthly data volume quota. The billing infrastructure may be implemented in software stored in a non-transitory computer readable medium, hardware, and/or a combination of software stored in a non-transitory computer readable medium and hardware. For example, the billing infrastructure may be a Gateway GPRS Support Node (GGSN). Although the billing infrastructure is shown in FIG. 1 as located external to the radio access network 112, in other embodiments, the billing infrastructure may be a part of the radio access network.

The zero rating proxy 116 is configured to redirect a request that is directed to a third party URL from the end-user device 102 to a zero rating URL and to perform a URL transformation in response to the redirected request. In an embodiment, the zero rating URL may be the URL of the zero rating proxy. In an embodiment, the zero rating proxy intercepts communications messages that are directed to a third party URL from the end-user device and redirects the communications messages to a single domain that is zero rated. In an embodiment, the zero rating URL is a URL to which a request is directed or from which a response is received, which is not counted toward a data quota of a network operator and/or is not charged as traffic volume by the network operator. That is, a zero rating URL is a URL that allows for “free of charge” traffic. The zero rating proxy may be implemented in software stored in a non-transitory computer readable medium, hardware, and/or a combination of software stored in a non-transitory computer readable medium and hardware. In the embodiment depicted in FIG. 1, the third party URL may be pointed to the third party application backend 108 or the third party website 110. In addition, the billing infrastructure 114 performs billing a function of the network operator of the access network 104. Because the URL redirection and transformation are performed by the zero rating proxy, third parties do not need to invest resources and time to redesign/rewrite their services/applications to use specific domains.

Although the zero rating proxy 116 is shown in FIG. 1 as being part of the access network 104, the zero rating proxy can be located anywhere within the network architecture 100. In addition, the zero rating proxy can be located in a single device or distributed amongst multiple devices. In an embodiment, the zero rating proxy is located anywhere in the data path between the end-user device 102 and the third party application backend 108 and the third party website 110. The zero rating proxy may be integrated within the radio access network 112 or located within the Internet 106. For example, the zero rating proxy may be located in a base station or a data center in the radio access network of a wireless carrier, such as, a cellular communications carrier. In another example, the zero rating proxy is integrated within an Internet gateway (not shown) of a wireless ISP or a wired ISP that manages the access network. In yet another embodiment, the zero rating proxy is located in the Internet as well as in a private network. For example, some component of the zero rating proxy is located in the Internet while the rest of the zero rating proxy is located in the private network.

In an embodiment, the zero rating proxy 116 receives at least one request that is directed to a third party URL, which may be pointed to the third party application backend 108 or to the third party website 110, from the end-user device 102. The zero rating proxy instructs the end-user device to redirect the request to a zero rating URL. After the instruction, the zero rating proxy receives a request that is directed to the zero rating URL from the end-user device, where the request that is directed to the zero rating URL is received in response to the instruction. The zero rating proxy rewrites the request that is directed to the zero rating URL into at least one request that is directed to the third party URL. Then, the zero rating proxy receives at least one response to the at least one request from the third party URL and rewrites the at least one response into at least one response that is from the zero rating URL. The request that is directed to the zero rating URL may include one of a session cookie, a header, and a query-string that is used to notify the zero rating proxy. The zero rating proxy may make a subsequent request that is directed to the third party URL on behalf of the end-user device. Subsequent requests from the end-user device that are directed to the third party URL are redirected to the zero rating URL. Although the network architecture 100 is shown in FIG. 1 as including one zero rating proxy, in other embodiments, the network architecture may include more than one zero rating proxy. For example, the network architecture may include multiple zero rating proxies and each of zero rating proxies performs some of the operations described above. In an embodiment, instead of being performed by the zero rating proxy, the redirection to the zero rating URL may be performed by another component of the network architecture. For example, the redirection to the zero rating URL can be a function performed by the zero rating proxy as previously described or alternatively initiated by the third party application website and/or the third party application backend directly.

The third party application backend 108, as well as the third party website 110, is configured to receive one or more requests from the end-user device 102 via the access network 104. The third party application backend, as well as the third party website, also generates one or more responses and transmits the generated responses to the end-user device. The response may include one or more webpage files, one or more text files, one or more image files, one or more audio files, or one or more video files, or any combination thereof. The third party application backend can be any application backend, which provides a service or services to one or more end-user devices. The third party application backend may include one or more server programs that run at one or more URLs. For example, the third party application backend may be a game host program that connects multiple players to play an online game, tracks the progress of the players, and keeps scores for the players. In an embodiment, the third party application backend is a smart phone application (App) backend, such as an Apple iPhone App backend or a Google Android App backend. The third party website can be any website. The third party application backend may be implemented in software stored in a non-transitory computer readable medium, hardware, and/or a combination of software stored in a non-transitory computer readable medium and hardware. In an embodiment, the third party website 110 is a website for a smart phone App, such as an Apple iPhone App or a Google Android App or any third party web content including one or more CDN networks. The third party application backend and the third party website may belong to a single entity or different entities or be managed by a single entity or different entities. For example, the third party application backend and the third party website may belong to a single smart phone App. In the embodiment depicted in FIG. 1, the third party application backend and/or the third party website does not belong to the network operator of the access network and are not managed by the network operator of the access network.

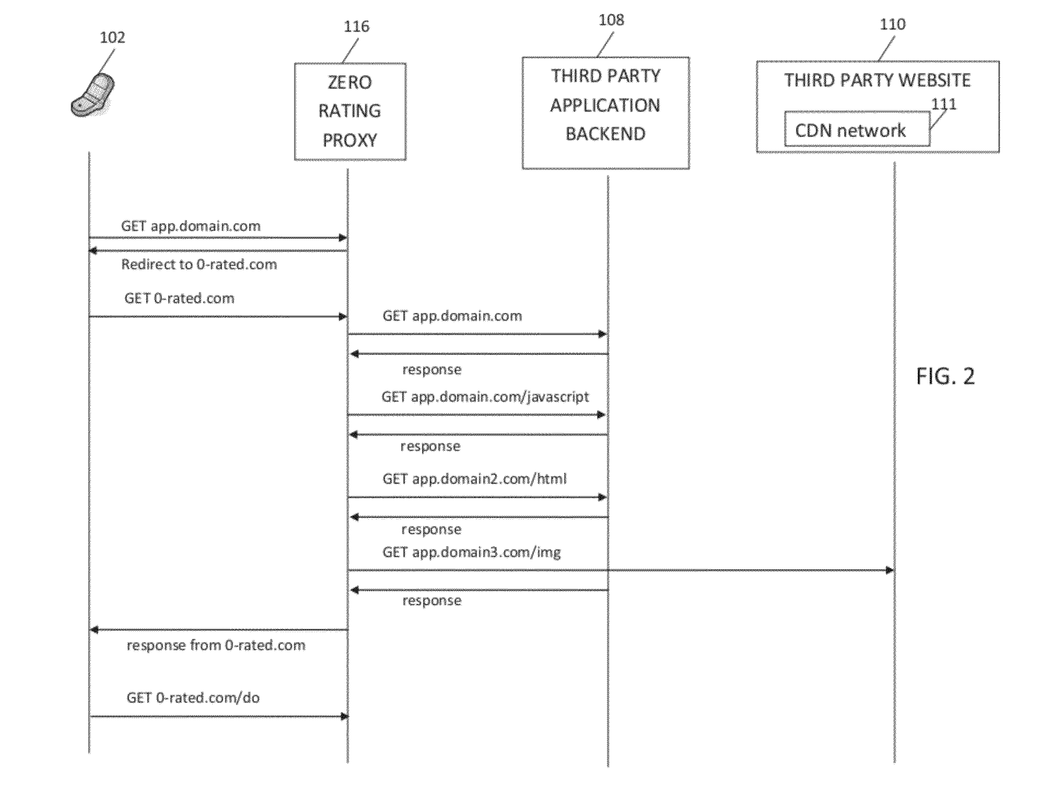

FIG. 2 illustrates an exchange of messages that is used to implement an operation of the zero rating proxy 116 of FIG. 1. In a first operation, the end-user device 102 sends a request message, such as “GET app.domain.com,” that is directed to the third party application backend 108 or the third party website 110. In an embodiment, the initial redirection is performed by the third party application backend 108. The zero rating proxy 116 intercepts the request message and instructs the end-user device to redirect requests to the zero rating URL, for example, “0-rated.com,” by sending a message such as “redirect to 0-rated.com” to the end-user device. The zero rating URL, for example, “0-rated.com,” may be the URL of the zero rating proxy. The zero rating proxy may store URLs of eligible third party application backends and the third party websites and monitor the communications traffic from the end-user device to intercept relevant request messages and to instruct the end-user device to redirect the requests to the zero rating URL. The interception process can include (without being limited to) traffic resource metering (time and/or volume) in order to apply specific policy and charging rules over the zero rated traffic (for instance the zero rating has a limited validity in time or amount of data volume). After being instructed by the zero rating proxy, the end-user device sends one or more request messages, such as “GET 0-rated.com,” that is redirected to the zero rating URL. The request from the end-user device is in a zero-rated domain, such as, O-rated.com in FIG. 2. The zero rating proxy receives the request that is directed to the zero rating URL from the end-user device in response to the instruction. The request that is directed to the zero rating URL may include at least one of a session cookie, a header, and a query-string that is used to notify the zero rating proxy of the URL redirection. That is, the zero rating proxy is configured to intercept the session cookie, the header, and/or the query-string as a URL redirection indicator required to confirm the validity of the request.

After the zero rating proxy 116 receives the redirected request, such as “GET 0-rated.com,” form the end-user device 102, the zero rating proxy performs the URL transformation in response to the redirected request. In an embodiment, the zero rating proxy rewrites the request that is directed to the zero rating URL into at least one request that is directed to the third party URL, for example, by URL tokenization. As shown in FIG. 2, the zero rating proxy rewrites the redirected request “GET 0-rated.com” into four requests to the third party application backend 108 and the third party website 110. The four requests include “GET app.domain.com,” “GET app.domain.com/javascript,” and “GET app.domain2.com/html,” which are directed to the third party application backend, and “GET app.domain3.com/img,” which is directed to the third party website. In the embodiment depicted in FIG. 2, the third party application backend has URLs at “domain.com” and “domain2.com” and the third party website (including the CDN 111) has URLs at “domain3.com.” The zero rating proxy may perform the URL rewrite operation based on information within the session cookie, the header, and/or the query-string of the redirected request from the end-user device. The third party application backend and the third party website respond to the requests from the zero rating proxy with responses that include requested information and file(s). The zero rating proxy receives the responses to from the third party application backend and the third party website and rewrites the responses into at least one response that is from the zero rating URL, such as “0-rated.com.” The rewritten response that is from the zero rating URL is then transmitted to the end-user device with requested information and file(s) after having been manipulated to rewrite any embedded URLs/URIs still referencing the original content (typically in HTML files). Thus, the response from the zero rating proxy to the end-user device is in a zero-rated domain, such as, 0-rated.com, and any subsequent requests from the end-user device will remain in this zero-rated domain.

Instead of sending subsequent requests that are directed to third party URLs to the zero rating proxy, the end-user device sends subsequent requests that are directed to the zero rating URL to the zero rating proxy. Because requests from the end-user device to the zero rating proxy and the responses from the zero rating proxy to the end-user device are in a zero-rated domain, for example, 0-rated.com in FIG. 2, the communications of these messages do not get charged for data traffic volume or get charged differently than the typical billing mode (for example, charged on a monthly fee rather than per Mbytes) as they may not count toward the data volume quota of the user of the end-user device by the billing infrastructure 114 in FIG. 1.

There is no straight forward solution available that does not need to redesign/rewrite third parties' services/applications to use as few domains/URLs as possible or to provision a large number of URL in carrier billing infrastructures. The zero rating proxy 116 redirects requests that are directed to a third party URL from the end-user device 102 to a zero rating URL and performs a URL transformation in response to the redirected requests. Because the URL redirection and transformation are performed by the zero rating proxy, third parties do not need to invest resources and time to redesign/rewrite their services/applications to use specific domain or domains.

Using the zero rating proxy 116, multiple third party URLs can be redirected to a few zero rating URLs. By redirecting multiple requests that are directed to third party URLs to a few zero rating URLs, the network operator of the access network 104 only needs to provide zero rating services for the few zero rating URLs. Thus, the network operator can save network resources and development and maintenance costs by selectively charging the communications of its subscribers.

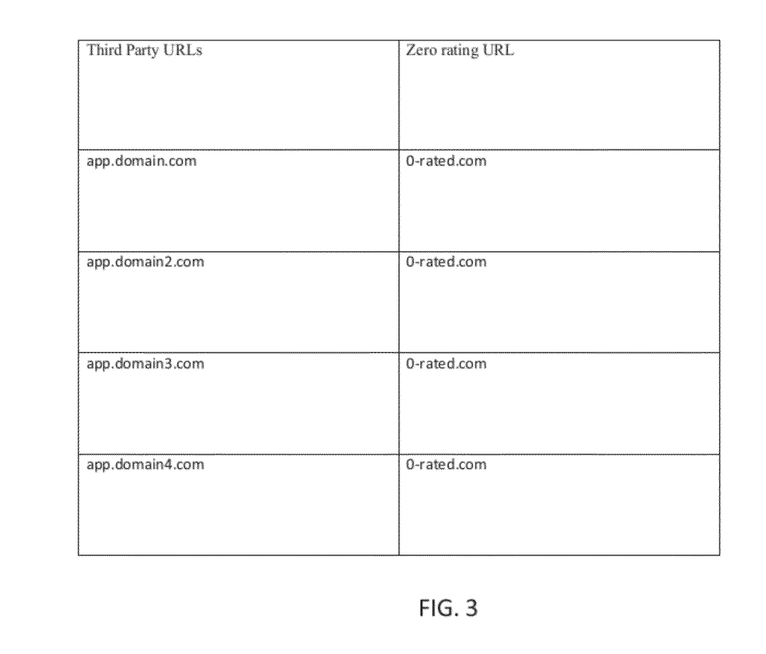

FIG. 3 shows an example redirection between third party URLs and a zero rating URL of the zero rating proxy 116 depicted in FIG. 1. In the example redirection, requests that are directed to third party URLs such as “app.domain.com,” “app.domain1.com,” “app.domain2.com,” and “app.domain3.com” are redirected to a single zero rating URL, which is “0-rated.com.” As described above, there is no straight forward solution available that does not need to redesign/rewrite third parties' services/applications to use a single domain/URL or to provision a large number of URL in carrier billing infrastructures. By redirecting all requests that are directed to third party URLs to the same zero rating URL, the network operator of the access network 104 only needs to provide zero rating service for one zero rating URL, which can greatly save network resources and development and maintenance costs and provide a universal solution for all of the third party applications that demand zero rating services (for serving free traffic or subscription-based content model).

It should be noted that “domain.com,” “domain1.com,” “domain2.com,” and “domain3.com” shown in FIGS. 2 and 3 are used merely to represent third party URLs. In addition, it should be noted that “0-rated.com” shown in FIGS. 2 and 3 is used merely to represent a zero rating URL.

Although the operations herein are shown and described in a particular order, the order of the operations may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

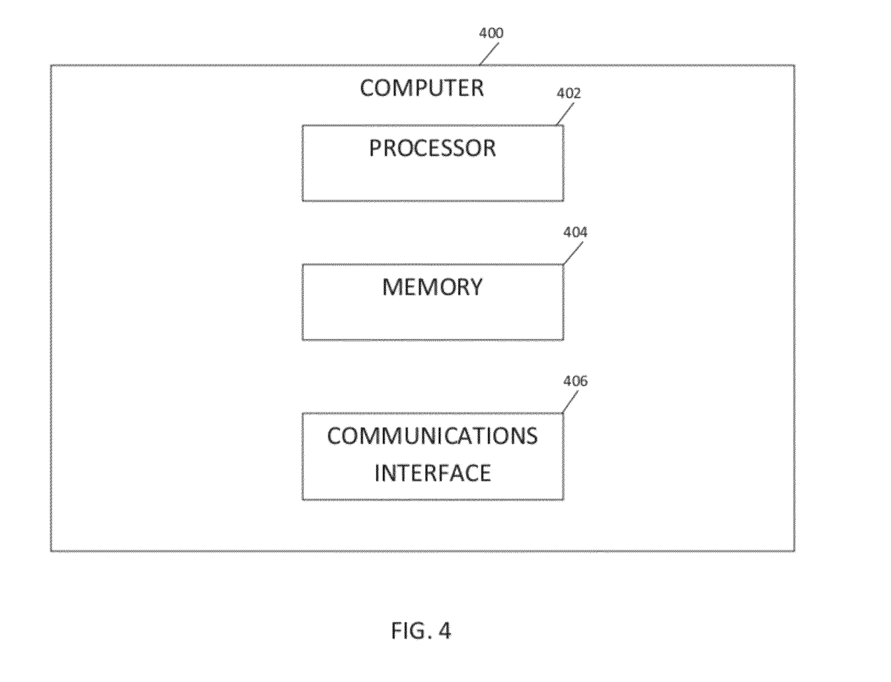

In an embodiment, at least one of the functionalities of components of the network architecture 100, such as the zero rating proxy 116 and/or the billing infrastructure 114, is performed by a computer that executes computer readable instructions. FIG. 4 depicts a computer 400 that includes a processor 402, memory 404, which is a non-transitory computer-readable medium or a non-transitory computer-readable memory, and a communications interface 406. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

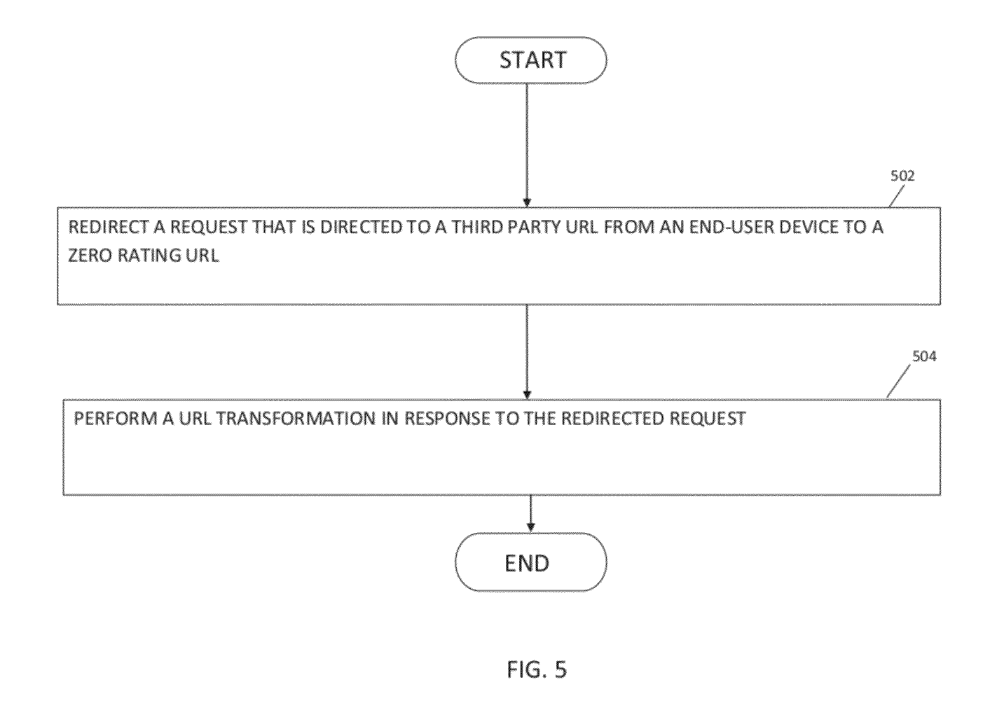

FIG. 5 is a process flow diagram of a method for providing a zero rating service to an end-user device in accordance with an embodiment of the invention. At block 502, a request that is directed to a third party URL from an end-user device is redirected to a zero rating URL. At block 504, a URL transformation is performed in response to the redirected request.

While the embodiments refer to the zero rating capabilities, an end-user or end-users might actually be charged for the traffic but against a billing criteria different than the typical billing mode (e.g., access to some content for a monthly fee rather than per Mbyte). Zero rating is used with the broader meaning generally adopted by a telephone company (telco), which provides telecommunications services such as telephony and data communications, and billing vendors independently of the final billing terms for the end-users.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for providing a zero rating service to an end-user device, the method comprising:
redirecting a request that is directed to a third party URL from an end-user device to a zero rating URL; and
performing a URL transformation in response to the redirected request.

2. The method of claim 1, wherein redirecting the request that is directed to the third party URL comprises:
receiving the request that is directed to the third party URL from the end-user device;
instructing the end-user device to redirect the request to the zero rating URL; and
receiving a request that is directed to the zero rating URL from the end-user device, wherein the request that is directed to the zero rating URL is received in response to the instruction.

3. The method of claim 2, wherein performing the URL transformation in response to the redirected request comprises:
rewriting the request that is directed to the zero rating URL into at least one request that is directed to the third party URL;
receiving at least one response to the at least one request from the third party URL; and
rewriting the at least one response into at least one response that is from the zero rating URL.

4. The method of claim 3, wherein the zero rating URL is a URL that a request that is directed to or a response that is from is not counted toward a data quota of a network operator.

5. The method of claim 3, wherein the zero rating URL is a URL that a request that is directed to or a response that is from is not charged as traffic volume by a network operator.

6. The method of claim 3, wherein receiving the request that is directed to the zero rating URL comprises receiving the request that is directed to the zero rating URL over a wireless communications channel, wherein the at least one response that is from the zero rating URL is transmitted to the end-user device over the wireless communications channel, and wherein the zero rating URL is a URL that a request that is directed to and a response that is from are not counted toward a data quota by an operator of the wireless communications channel and are not charged as traffic volume by the operator of the wireless communications channel.

7. The method of claim 3, wherein the request that is directed to the zero rating URL includes one of a session cookie, a header, and a query-string that is used to notify the zero rating proxy.

8. The method of claim 1, wherein subsequent requests from the end-user device that are directed to the third party URL are redirected to the zero rating URL.

9. The method of claim 1 further comprising using the zero rating proxy to make a subsequent request that is directed to the third party URL on behalf of the end-user device.

10. The method of claim 1, wherein the third party URL is pointed to a third party application backend.

11. The method of claim 1, wherein the third party URL is pointed to a third party website.

12. A method for providing a zero rating service to an end-user device, the method comprising:
intercepting communications messages that are directed to a third party URL from an end-user device; and
redirecting the communications messages to a single domain that is zero rated.

13. The method of claim 12, wherein the single domain is a domain that a request that is directed to or a response that is from is not counted toward a data quota of a billing infrastructure.

14. The method of claim 12, wherein the single domain is a domain that a request that is directed to or a response that is from is not charged as traffic volume by a billing infrastructure.

15. A method for providing a zero rating service to an end-user device, the method comprising:
receiving a request that is directed to a third party URL from an end-user device at a zero rating proxy;
instructing the end-user device to redirect the request to a zero rating URL using the zero rating proxy;
receiving a request that is directed to the zero rating URL from the end-user device at the zero rating proxy, wherein the request that is directed to the zero rating URL is received in response to the instruction;
rewriting the request that is directed to the zero rating URL into at least one request that is directed to the third party URL using the zero rating proxy;
receiving at least one response to the at least one request from the third party URL at the zero rating proxy; and
rewriting the at least one response into at least one response that is from the zero rating URL using the zero rating proxy.

16. The method of claim 15, wherein the zero rating URL is a URL that a request that is directed to or a response that is from is not counted toward a data quota of a network operator.

17. The method of claim 15, wherein the zero rating URL is a URL that a request that is directed to or a response that is from is not charged as traffic volume by a network operator.

18. A system for providing a zero rating service to an end-user device, the proxy is configured to:
redirect a request that is directed to a third party URL from an end-user device to a zero rating URL; and
perform a URL transformation in response to the redirected request.

19. The system of claim 18, wherein the zero rating URL is a URL that a request that is directed to or a response that is from is not counted toward a data quota of a network operator.

20. The system of claim 18, wherein the zero rating URL is a URL that a request that is directed to or a response that is from is not charged as traffic volume by a network operator.

21. A proxy for providing a zero rating service to an end-user device, the proxy is configured to:
receive a request that is directed to a third party URL from an end-user device;
instruct the end-user device to redirect the request to a zero rating URL;
receive a request that is directed to the zero rating URL from the end-user device, wherein the request that is directed to the zero rating URL is received in response to the instruction;
rewrite the request that is directed to the zero rating URL into at least one request that is directed to the third party URL;
receive at least one response to the at least one request from the third party URL; and
rewrite the at least one response into at least one response that is from the zero rating URL.

22. The proxy of claim 21, wherein the zero rating URL is a URL that a request that is directed to or a response that is from is not counted toward a data quota of a network operator.

23. The proxy of claim 21, wherein the zero rating URL is a URL that a request that is directed to or a response that is from is not charged as traffic volume by a network operator.
